(19) United States
(12) Patent Application Publication
(10) Pub. No.: US 2003/0154802 A1
(43) Pub. Date: Aug. 21, 2003

(54) Strain transducer

(76) Inventors: Brian Culshaw, Kilmacolm Renfrew (GB); Nicolas O'Hear, Schoonhoven (NL); Michael Richard Parsey, Arbroath Angus (NL); Deepak Gulabrai Uttamchandani, Glasgow (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/311,727

(22) PCT Filed: Apr. 27, 2001
(86) PCT No.: PCT/GB01/01903

(30) Foreign Application Priority Data
Jun. 20, 2000 (GB) 0014936.9

(51) Int. Cl. G01L 1/24

(52) U.S. Cl. 73/800

(57) ABSTRACT

A strain transducer strand (10) is provided comprising an elongatable central core (12) around which are helically wound one or more plastic tubes (14) each of which contains an optical fibre (16). Each tube (14) is overfilled with the optical fibre (16), such that the fibre (16) is longer than the tube (14). As the transducer strand (10) experiences strain, the core (12), plastic tubes (14), and optical fibres (16) elongate, with the helical winding acting as gearing to produce a reduced elongation in the fibres (16) proportional to the elongation of the transducer strand (10). The degree of elongation may be detected by monitoring the optical properties of light transmitted along the fibres (16). The transducer strand is particulary intended for incorporation into elongate load bearing members, such as ropes.

The present invention relates to a strain transducer, for use with load bearing members and in particular with elongate tension members, such as ropes. The present invention relates also to a method and a system for detecting and/or localising strain on such tension members.

It is often desirable to be able to detect strain along the length of elongate tension members, in the form, for example, of extension or compression of the tension member. For example, a sudden increase in elongation and strain in a load-bearing rope may be an indication that the rope is weakening and may be liable to breakage.

Load-bearing ropes may be extremely long—for example, ropes used in marine mooring situations or in mineshafts may be over 1 km in length. A 1 km rope may, for example, fail at a local elongation of 10% . If such elongation is limited to only a 1 m section of rope, then this results in an elongation of just 10 cm, or one ten-thousandth of the overall length.

Therefore, it is important to monitor the elongation of the rope at all sections along its length. The use of many discrete strain sensors, such as an array of electrical strain gauges, along the rope is not practical: adequate coverage of a 1 km rope would require perhaps 1000 sensors at 1 m intervals which would be both costly, due to the large number of sensors required, and liable to failure. In use the strain gauges themselves would have to be connected to a conventional electrical cable which would also have to be able to withstand the elongation and fatigue experienced by the rope. At elongations above 1%, copper work hardens, becomes brittle and rapidly fails in fatigue. Further, each gauge would only measure the local strain at its point of attachment; any abnormal strain between these points could remain undetected. Finally, when not in use, ropes are generally coiled; bending of such sensors in this way would be liable to cause damage. If a sensor should become damaged while the rope is deployed at sea, accessibility for repairs would also be very restricted.

One approach for strain measurement overcoming the problems of discrete, electrically powered strain sensors is by the incorporation of optical fibres into the rope. It is known that certain properties of optical fibres are sensitive to strain, and these properties have been used to develop instruments that can measure the distribution of strain over the entire length of the optical fibre.

For example, it is known to use stimulated Brillouin scattering based instruments to detect strain on an optical fibre: see, for example, Chapter 9 “Stimulated Brillouin Scattering” in “Non-linear fibre optics” by G P Agrawal, Second Edition, Academic Press, 1995.

However, while a synthetic rope may retain integrity at as much as 10% elongation, a silica optical fibre will typically fail after only 1% elongation. Therefore, optical fibres alone cannot provide a satisfactory strain sensor for this application.

It is among the objects of the present invention to provide a strain detector capable of detecting local strains over substantially the whole length of a load bearing member. This is achieved, in part, by providing an optical fibre housed in a mechanical construction which limits the strain actually experienced by the fibre.

According to a first aspect of the present invention there is provided a strain transducer in the form of an elongate strand capable of being secured along its length to an existing load bearing member or capable of being integrated into a load bearing member during manufacture thereof, the strand comprising an elongate core, a tube which is helically wound around the core, and an optical fibre housed within the bore of the tube and anchored relative to the bore at at least two points.

By virtue of the present invention, when the strand is united with a load bearing member generation of strain on the load bearing member generates strain on the core which is passed to the helical tube. As the core stretches, the strain on the helical tube will alter proportionally. The degree of helical tube stretch may be varied by varying the angle of winding of the helical tube around the core.

Although the invention is particularly intended for use with elongate tension members, such as ropes, it will be readily apparent that the load bearing member need not be elongate, and further need not be a tension member. For example, a strain transducer in accordance with the present invention may be secured to a surface such as that of a structural panel member to detect strain over the adjoining regions of the surface. Furthermore, one or more strain transducers according to the invention may be incorporated into a network or a mesh of elongate load bearing members, such as fibres. Alternatively, the load bearing member may take the form of a shock absorber or damping member, for example, railway buffers, crash barriers, and the like. Similarly, a strain transducer may be used to detect strain in a supporting structural element, such as a concrete pillar or the like, which will be generally under compression rather than tension; when used in such detection of compression, the strain transducer will generally be prestretched, to provide an initial tension in the optical fibre.

In addition, a load bearing member such as a rope or the like may include a strain transducer along the whole or only a portion of its length. For example, ropes may be provided with looped ends for securing the rope to a firm location; in such circumstances, the loop of the rope typically experiences the greatest strain. Thus, a transducer according to the present invention may be incorporated into a rope only in a loop thereof, to monitor strain specifically in the loop.

It will be further understood that “load bearing member”, as used herein, need not necessarily refer to a member with a primary function of load bearing; the member may in fact have other primary functions. For example, the load bearing member may be used as a communications cable, umbilical cable, fuel or air supply cables, and the like.

The load bearing member may further be, for example, a bungee rope or other high-strain member or the like; or the load bearing member may be a member used as an elastic motor or similar. Numerous other possible applications for a strain transducer according to the present invention will be readily apparent to the skilled person.

Preferably the optical fibre is single-mode optical fibre; it is believed that single-mode optical fibre is most suited to the apparatus and methods described herein. However, multi-mode optical fibre may nonetheless be used in conjunction with certain measurement methods, as will be apparent to the skilled person.

Preferably, the diameter of the tube bore is substantially greater than the diameter of the fibre and the fibre is capable of moving within the bore. Such an arrangement results in the optical fibre moving towards the walls of the tube when the core elongates, without initially being put under strain. Once the fibre has contacted the walls of the tubing, any further elongation will place the fibre under strain. In this way, an initial degree of elongation will not be detected by the transducer. Preferably also the optical fibre is longer than the length of the tube and the fibre is completely contained within the tube; that is, the fibre is overfilled in the tube. This also provides an initial degree of strain-free elongation as the fibre overfill is taken up. The relative dimensions of the tube bore and the fibre diameter, and the excess length of the optical fibre may be selected to provide an appropriate threshold of strain-free elongation for a particular application.

Conveniently the tube is a plastics tube. Alternative constructions of tube may of course be used; for example, elastomeric or the like. However, for high pressure water resistance a metallic tube may be employed.

Preferably the tube also contains a viscous fluid, to centralise the optical fibre and to restrict the free movement of the optical fibre. In a preferred embodiment, the viscous fluid is a gel; for example, the gel may be that sold under the name OC38, produced by H B Fuller. Alternatively, the tube may be largely solid, with a restricted bore containing the optical fibre (known in the art as “tight buffered”).

It has been found that, based on experimental data thus far, it is generally not necessary to separately anchor the optical fibre within the tube, particularly when the optical fibre is tight buffered, or where the tube contains a viscous fluid; friction here anchors the fibre relative to the tube sufficiently for strain to be tranmitted from the tube to the fibre. Certain embodiments of the invention may, nevertheless, include attachment points between the optical fibre and the tube; for example, the fibre may be bonded to the inner wall of the tube at either end thereof.

Preferably the helical wind angle of the tube is within the range 0°to 90°. A restricted helical wind angle range of 10°to 65°is preferred. The specific wind angle selected for each application depends on the desired core-to-optical fibre elongation ratio. It will of course be understood that the direction of winding may be clockwise or anticlockwise.

Preferably the core comprises synthetic load-bearing fibres; for example, aramid fibres, or synthetic elastomers. Alternatively, the core may comprise a flexible member, for example, solid or hollow cylinders of polymeric material, such as polypropylene.

Certain embodiments of the invention may provide a plurality of tubes, each containing an optical fibre, helically wound around the core. The precise number of tubes may depend on the size of the core, and the desired properties of the transducer strand. Conveniently at least some of the tubes may have different strain-free elongation thresholds (themselves determined by the bore size of the tubes, and the amount of overfill of the optical fibres, and the like). This provides the transducer with a range of sensitivities in which it will function. Thus, for example, one tube may detect elongation of the load bearing member from 4% to 5%, after which the fibre will break; while a second tube detects elongations from 5% to 6%; and so on. The final fibre may only break at elongations of 10% to 11%, at which the load bearing member itself will break.

Preferably the transducer strand is contained inside a protective sheath. This may be a plastics sheath, or of any suitable material known in the art.

Certain embodiments of the invention may further provide a “reference” tube containing an optical fibre, which does not experience tension when the remainder of the fibres do so. Conveniently said reference tube may form part of the core of the strand. For example, the reference tube may be significantly overfilled with the optical fibre, such that the fibre will not experience strain until at least the breaking threshold of the load bearing member. This tube may be used as the core of the present invention, or may be incorporated into the transducer strand as a separate tube. This reference tube may be used to provide a non-extended measurement of the transducer to compare with a simultaneous extended measurement, and thereby compensate for variations in temperature experienced by the transducer strand.

Alternatively, one or more reference tubes may be provided with a helical winding angle which differs from that of the remainder of the tubes. Again the different measurements obtained under tension from the differently-wound tubes may be compared to provide a degree of temperature compensation, although the reference tubes in this embodiment will be subjected to some strain on application of tension to the strand.

Conveniently the transducer strand comprises a core around which is wound a first layer of tubes at a first winding angle, with a further second layer of tubes wound around the first layer at a second winding angle. Sheaths may be provided around either or both of the first layer and the second layer of tubes.

According to a second aspect of the present invention, there is provided a load bearing member comprising a number of load bearing strands, and a strain transducer strand, the transducer strand comprising an elongate core, a tube which is helically wound around the core, and an optical fibre housed within the bore of the tube and anchored relative to the bore at at least two points.

The load bearing member may be a rope, a sling, or a web, or indeed any of the types of load bearing members referred to herein. The load bearing member may be of natural materials (eg, sisal, hemp); synthetic materials (eg, aramid, polyester); metal (eg, steel); and the like. The load bearing member may serve additional or alternative functions to load bearing, for example, communications cables, fuel or air supply cables, and the like. Selected applications for load bearing members according to the present invention include, but are not limited to, deep sea mooring cables, balloon or other mooring ropes, and construction support cables, for example, such as used in suspension bridges.

In certain embodiments of the invention, the strain transducer strand may be incorporated into the winding of the load-bearing strands as an integral part of the load bearing member; while in other embodiments the transducer strand may be secured externally of the load-bearing strands as a substantially separate strand. The transducer strand may itself be wound around or with the load-bearing strands, or may extend substantially parallel to the longitudinal axis of the load bearing member.

The load bearing member may further comprise a plurality of strain transducer strands.

According to a further aspect of the present invention, there is provided a method of detecting strain in a load bearing member, the method comprising the steps of:

providing in combination a strain transducer strand comprising an elongate core, a tube which is helically wound around the core, and an optical fibre housed within the bore of the tube and anchored relative to the bore at at least two points; and a load bearing member;

transmitting optical radiation along the optical fibre; and

detecting a change in the character of the optical radiation in the optical fibre resulting from a change in the strain experienced by the optical fibre.

“Optical radiation” will be understood to include not only visible optical radiation, but any suitable electromagnetic radiation, including infra-red, radio waves, and microwaves.

The strain transducer strand may be incorporated within the load bearing member; or the strand may be attached externally to the load bearing member.

In one embodiment, the detection method makes use of stimulated Brillouin scattering to detect strain on the optical fibre.

In an alternative embodiment, the detection method may use a concatenation of fibre optic Bragg gratings as reflectors to detect elongation of the optical fibre between successive Bragg gratings, using, for example, a microwave/radio-frequency sub-carrier based strain measuring technique. A still further method may make use of the changes in attenuation of the optical signal induced by the elongation of the strain transducer

According to a further aspect of the present invention, there is provided a system for detecting strain in a load bearing member, the system comprising a strain transducer strand comprising an elongate core, a tube which is helically wound around the core, and an optical fibre housed within the bore of the tube and anchored relative to the bore at at least two points; means for generating optical radiation; and means for detecting optical radiation.

Conveniently, the optical radiation generator and detector may be provided in a single unit.

In a preferred embodiment, the optical generator may be a modulated laser. Conveniently this laser may generate infra-red light.

These and other aspects of embodiments of the present invention will now be described, by way of example only, with reference to the accompanying drawings in which:

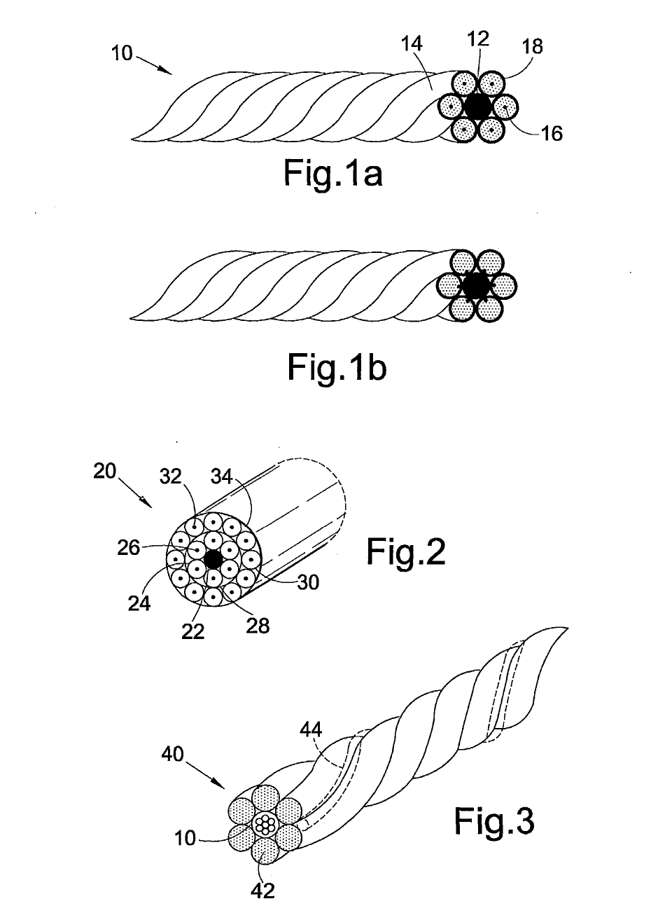

FIGS. 1a and 1b show a strain transducer strand in accordance with a first aspect of the present invention, in relaxed and strained forms, respectively;

FIG. 2 shows an alternative strain transducer strand in accordance with a further embodiment of the invention;

FIG. 3 shows a rope incorporating the strain transducer strand of FIG. 1;

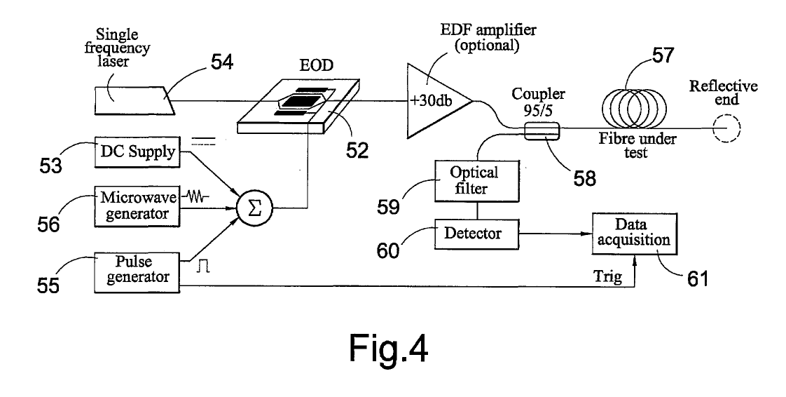

FIG. 4 shows an apparatus for measuring strain on a tension member using a strain transducer strand in accordance with the present invention;

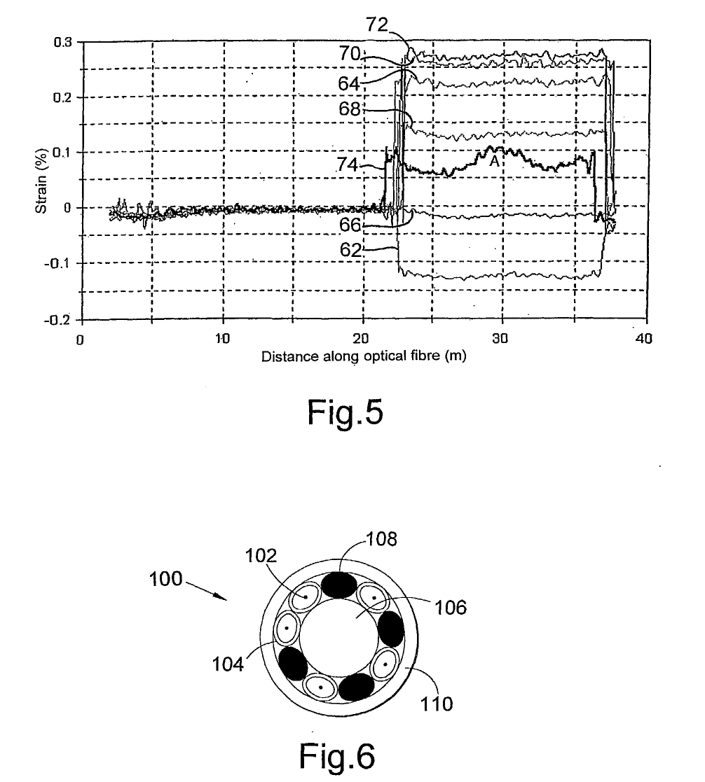

FIG. 5 shows the results of an experiment carried out using the apparatus of FIG. 4;

FIG. 6 shows a further strain transducer strand in accordance with an embodiment of the present invention;

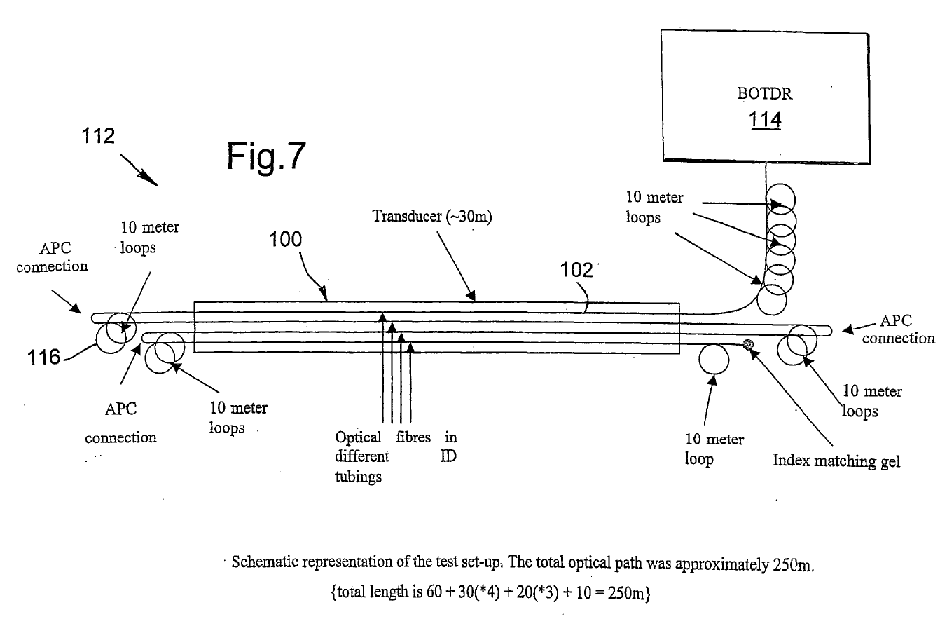

FIG. 7 shows a further apparatus for measuring strain on a tension member using the strain transducer strand of FIG. 6;

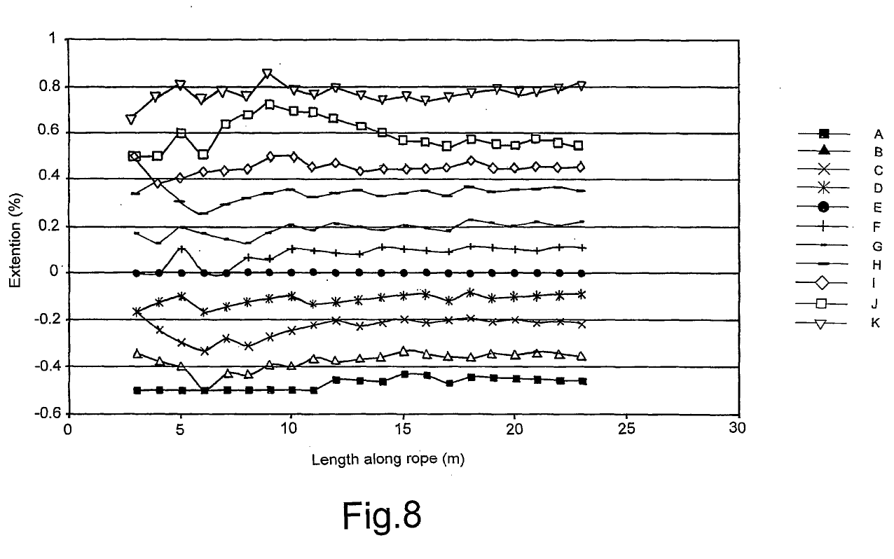

FIG. 8 shows a graph of visual measurement of extension on a rope incorporating the transducer of FIG. 6 under different loads; and

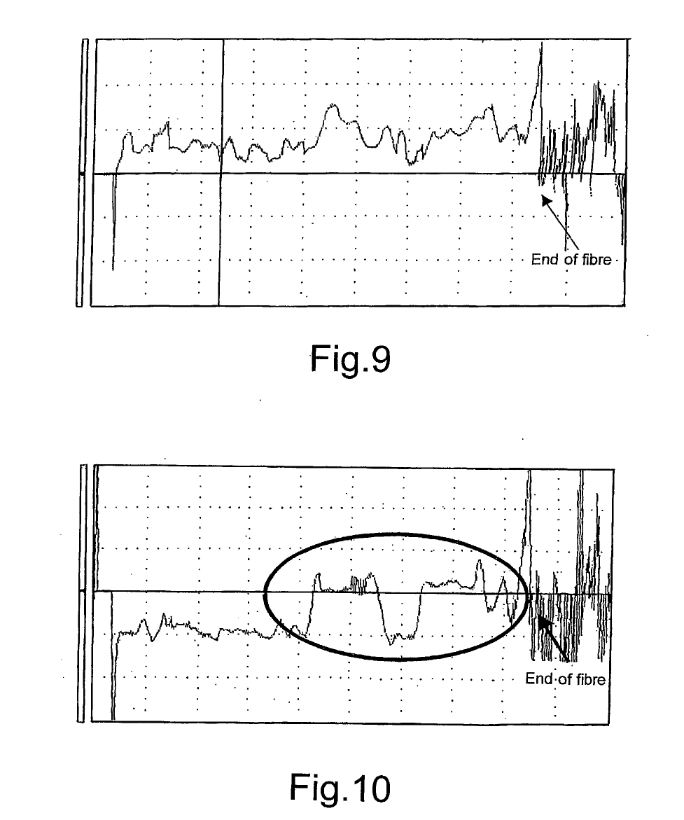

FIGS. 9 to 12 show graphs of the strain experienced by a rope incorporating the transducer of FIG. 6 under different loads, as measured by the apparatus of FIG. 7.

Referring first of all to FIG. 1a, this shows a strain transducer strand 10 in accordance with one embodiment of the present invention. The strand 10 comprises an elongatable central core 12 formed of nylon fibres around which are helically wound six plastic tubes 14, each of which contains a single mode optical fibre 16 surrounded by optical fibre maintenance gel 18. The ends of each fibre 16 are clamped to the tube to prevent slippage of the fibre within the tube. The bore of each tube 14 is substantially larger than the diameter of each optical fibre 16. Each tube 14 is “overfilled” with the optical fibre 16, such that the fibre 16 is longer than the tube 14, although the fibre is still contained entirely within the tube.

As the transducer strand 10 is put under strain, the core 12 elongates, as do the plastic tubes 14 and optical fibres 16. Due to the helical winding of the tubes 14, however, this elongation is proportional to, but less than, that of the central core 12. For an initial degree of stretch, the situation illustrated in FIG. 1b prevails: the fibres 16 move to the inner walls of the tubes 14, while the overfill provides a certain amount of strain-free elongation of the fibres 16. Any further elongation will put the optical fibres 16 under strain, which can therefore be measured as a reflection of strain on the core 12 beyond a certain initial limit.

In use, the transducer strand 10 may also be enclosed in a sheath (not shown) to protect the components from damage.

An alternative form of transducer strand is shown in FIG. 2. The strand 20 comprises, as does that of FIG. 1a, a nylon core 22 around which are helically wound plastic tubes 24 and optical fibres 26. This first layer of tubes 24 is enclosed in a plastic sheath 28. Outside this sheath 28, however, is a second layer of plastic tubes 30 and optical fibres 32, with a different helical wind angle from the first layer. This provides the second layer with a different but proportional response to strain from that of the first, which difference may be used to calibrate a strain measurement, and so account for temperature fluctuation in the transducer strand 20. The whole strand is further enclosed in an outer plastic sheath 34.

FIG. 3 shows the transducer strand 10 of FIG. 1 as it may be incorporated in a tension member, in this case a rope. The rope 40 comprises a number of bundles of fibres 42 of polyester which are helically wound together to form a single member. At the centre of the rope 40 is a strain transducer 10 as described, which is incorporated into the structure of the rope 40 as if it were a fibre bundle 42. When the rope 40 is placed under strain, the strain is transmitted to the transducer 10 at the centre of the rope 40. An alternative location for a transducer strand 10 on a rope 40 is shown on FIG. 3 in chain-dotted outline, denoted by numeral 44. The strand 10 is wound around the outside of the rope 40 in the helical groove provided between two of the bundles of polyester fibres 42. This location for the transducer 10 is suitable for retrofitting the transducer strand 10 to an existing conventional rope, rather than preparing a specially-made rope. Of course, a strand 10 may be retrofitted to an existing rope or other member in numerous alternative manners, and it will be apparent that the member need not possess such a groove for retrofitting to take place.

The strain experienced by the optical fibres of the present strain transducer may be measured in a number of ways. One such method, using stimulated Brillouin scattering, has been used experimentally on a test transducer, making use of an arrangement as illustrated in FIG. 4 (derived from M Niklés, L Thévenaz, P A Robert, “Simple distributed fibre sensor based on Brillouin gain spectrum analysis”, Optics Letters, vol 21, no 10, pp758-760, 1996).

The arrangement includes an electro-optic modulator (EOM) 52 connected to a laser 54, and to a DC power supply 53, microwave generator 56, and pulse generator 55. The fibre under test 57 receives modulated laser light input from the EOM 52. The returned light from the optical fibre is directed via a coupler 58 to an optical filter 59 and detector 60, which passes electrical signals to a data acquisition device 61, also receiving input from the pulse generator 55.

To operate the test arrangement, a strong light pulse, the pump, is launched into the optical fibre. It crosses a weak CW probe signal that propagates in the opposite direction. Stimulated Brillouin scattering occurs when the two signals overlap resulting in the amplification of the probe signal. The electro-optic modulator 52 (EOM) is the key element in the setup since it is used, on the one hand, for pulsing the CW light from a single frequency laser 54 to form the pump pulse, and on the other hand for the generation and frequency tuning of the probe signal. The frequency shift on the probe laser light is achieved by applying a microwave signal from the generator 56 to the electro-optic modulator 52. This creates sidebands in the laser spectrum of the probe signal. When the microwave frequency is close to the Brillouin frequency shift, one of the sidebands of the probe light lies under the Brillouin gain spectrum and is amplified. The Brillouin gain spectrum, modified by the fibre strain, is determined by simply sweeping the microwave frequency applied to the modulator and recording the probe intensity (L Thévenaz, M Niklés, A Fellay, M Facchini, P Robert, “Truly distributed strain and temperature sensing using embedded optical fibres”, SPIE Proc., vol 3330, pp 301-314, 1998).

A length of parallel yarn aramid (Kevlar) rope with a continuous length of optical fibre embedded at the centre (laid parallel to the yarns, i.e. at 0° lay) was used for the experimental work. The optical fibre was not bonded to the aramid filaments. The rope had a calculated break strength (CBS) of 60 kN. The rope was subject to load increments, and at each step the fibre optic sensor was interrogated by the Brillouin system. The extension of the rope was measured separately. FIG. 5 presents the postprocessed data from a series of straining tests. The test machine provided data on the calibrated rope extension and could produce loads to 40 tonnes. The first half of the trace of FIG. 5 shows results from a length of reference fibre which always remained unstrained. Loading was applied to the rope incorporating the fibre sensor which, in FIG. 5, begins after the 21 metres point.

The load tests followed the following sequence —the corresponding results are also described:

The initial bias trace (under a load of 3kN; trace 62) shows that the optical fibre incorporated in the rope was initially in compression.

The second trace (under a load of 10kN; trace 64) shows that the unbonded optical fibre was able to pick up virtually all the rope strain —an extension of 58.8 mm on a reference length of 15.3 m is equivalent to 0.38% strain and the Brillouin system reported an increase from −0.13% to +0.22%.

The third trace (under a load of 2.48kN; trace 66) clearly shows that simply applying and removing the load once has removed most of the initial optical fibre compression. This behaviour is a typical synthetic rope bedding in process.

The fourth trace (under a load of 7.36kN; trace 68) again shows that the unbonded optical fibre was able to pick up virtually all the rope strain —an extension of 24 mm on a reference length of 15.3 m is equivalent to 0.16% strain and the Brillouin system reported an increase from −0.02% to +0.13%.

The fifth trace (under a load of 10.12kN; trace 70) still shows that the unbonded optical fibre was able to pick up virtually all the rope strain —an extension of 47mm on a reference length of 15.3 m is equivalent to 0.31% strain and the Brillouin system reported an increase from −0.02% to +0.27%.

The sixth trace (under a load of 10.24kN; trace 72) still shows that the unbonded optical fibre was able to pick up virtually all the rope strain - an extension of 51 mm on a reference length of 15.3 m is equivalent to 0.33% strain and the Brillouin system reported an increase from +0.02% to 30 0.28%.

The final trace (under a load of 5.12kN; trace 74) shows beyond any doubt that the Brillouin system can detect localised loss of strength (localised increase in strain; peak A) after the rope was deliberately damaged at its centre. This last result demonstrated the capabilities of the Brillouin system, in that it was able to clearly identify that the central portion of the rope was significantly weaker than the remainder.

These results show that the present invention is able to transfer strain from a structure under load to an optical fibre associated with the structure.

A second series of experiments was performed with a strain transducer strand. The strand used is shown in cross section in FIG. 6. The transducer 100 comprised five loosely buffered optical fibres 102 (that is, fibres contained within gel-filled tubes having some freedom to move within the tube, in contrast to “tight buffered” fibres). All of the optical fibres 102 were single mode, and each fibre 102 was contained in a protective tubing 104 with bore diameters of 0.5 mm, 1.0 mm, 1.5 mm, 2.0 mm, and 2.5 mm respectively. The fibres 102 were arranged with a helical wind angle of 34° about a soft rubber core 106 of 10 mm diameter. Spaces between the fibres 102 were filled with fillers 108 of 4 mm diameter. The whole assembly was further protected by an outer jacket 110 of soft polyurethane of 23 mm diameter.

To perform experimental measurements, the transducer 100 was incorporated into a test rope. The test rope was of parallel strand construction, with six strands in total. The rope had a diameter of 10 cm, and a breaking load of 60 tonnes. In addition, a strengthened central section of rope was produced by the addition of two extra strands.

The fibres in the transducer 100 were fusion spliced to connectorised 10 m pigtails 116 which were then connected end to end to allow all the fibres to be interrogated in a single scan using a Brillouin distributed strain measuring system. A schematic representation of the measurement apparatus 112 is shown in FIG. 7, from which it can be seen that each optical fibre 102 of the transducer 100 is connected in series to a Brillouin measurement arrangement 114 similar to that described above with reference to FIG. 4. The total optical path of the apparatus 112 was approximately 250 m.

The rope was “bedded in” prior to testing. This involved extending the rope from zero load to 1% extension over five cycles. This extension was achieved by applying a 1.5 tons (Imperial) load. The final cycle ended by maintaining this 1% extension for approximately 40 minutes.

To perform the straining tests, the rope was initially loaded to 2.5 tons so that it was taut. A tape measure was then fixed to the rope using cable ties, and marks made on the outer sheathing of the rope at 1 m intervals. These were used to make visual measurements of the extension experienced by different sections of the rope at various loads. The load was reduced to 0.5 tons, and visual measurements of extension and Brillouin OTDR (optical time domain reflectometer) measurements of strain distribution were performed. The load was then increased by 0.5 tons, and the measurements were repeated. This procedure was repeated up to a maximum load of 7.5 tons, although the visual measurements were discontinued at 5 tons for safety reasons.

The results of the visual extension measurement are shown in FIG. 8. From the lowermost trace to the uppermost trace on the graph, the traces represent loads of 0.5 ton (A), 1 ton (B), 1.5 tons (C), 2 tons (D), 2.5 tons (E), 3 tons (F), 3.5 tons (G), 4 tons (H), 4.5 tons (I), 5 tons (J), and 6 tons (K) As can be seen, the extension measurements made using the markings on the outer covering of the rope show that this covering was not noticeably strengthened at any particular zone, and so the results show only overall strain in the rope. This was most probably due to slippage of the outer covering with respect to the parallel strength members.

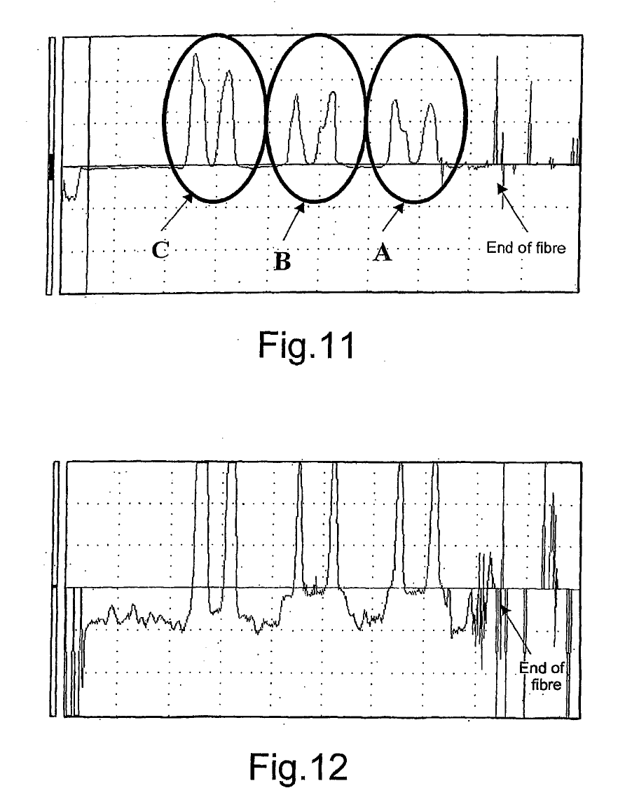

In contrast, the results of the Brillouin scans do show a differential response in the rope to the applied extension. Examples of the results obtained are shown in FIGS. 9, 10 and 11. The negative peaks on the left hand side of the traces represent the start of the transducer, that is, where the fibre enters the transducer. A 50 metre “dead zone” of optical fibre between the Brillouin OTDR and the transducer is not shown. FIG. 9 is a scan of the strain profile in the fibres with no load applied, and no obvious strain induced features are present. FIG. 10 is a scan of the strain in the fibres with a 4.5 ton load applied. The marked area shows that the fibres in the two smallest bore tubes are beginning to experience strain. FIG. 11 is a scan of the strain profile in the fibres with a 7.5 ton load applied. The scan shows that the fibres either side of the central section of the rope experienced significant levels of strain. The fact that the optical fibre within the central section of the rope has not been extended as much indicates that this was the strengthened section.

A “defect” was then introduced to the previously strengthened section of rope by cutting the external covering of the rope (which provided 25% of the overall strength) and half of each of the remaining strength members. This was done between the twelfth and thirteenth metre marks. FIG. 12 shows the strain distribution along the cascaded fibres at a load of 7 tons. The arrows indicate apparent strain detection at the region which coincides with where the point defect was introduced. This demonstrates that the system was sufficiently sensitive to detect a point defect in the rope.

These results demonstrate that the transducer described is able to detect local strain applied to a rope in which it is embedded. Furthermore, the fibres in the different tubes experienced extensions at different threshold levels, as expected. In addition, the results indicate that detection of point defects is possible.

1. A strain transducer in the form of an elongate strand capable of being secured along its length to an existing load bearing member or capable of being integrated into a load bearing member during manufacture thereof, the strand comprising an elongate core, a tube which is helically wound around the core, and an optical fibre housed within the bore of the tube and anchored relative to the bore at at least two points.

2. The transducer of claim 1 wherein the optical fibre is single-mode optical fibre.

3. The transducer of claim 1 or claim 2 wherein the diameter of the tube bore is substantially greater than the diameter of the fibre and the fibre is capable of moving within the bore.

4. The transducer of any preceding claim wherein the optical fibre is overfilled within the tube.

5. The transducer of any preceding claim wherein the tube also contains a viscous fluid, to centralise the optical fibre and to restrict the free movement of the optical fibre.

6. The transducer of claim 5 wherein the viscous fluid is a gel.

7. The transducer of any of claims 1 to 4 wherein the tube is largely solid, with a restricted bore containing the optical fibre.

8. The transducer of any preceding claim wherein the helical wind angle of the tube with respect to the longitudinal axis of the core is within the range 0°to 90°.

9. The transducer of claim 8 wherein the helical wind angle of the tube is within the range of 10°to 65°.

10. The transducer of any preceding claim wherein the core comprises synthetic load-bearing fibres.

11. The transducer of any of claims 1 to 10 wherein the core comprises a flexible member.

12. The transducer of any preceding claim comprising a plurality of tubes, each containing an optical fibre, helically wound around the core.

13. The transducer of claim 12 wherein at least some of the optical fibres of said plurality of tubes have different strain-free elongation thresholds.

14. The transducer of any preceding claim wherein the transducer strand is contained inside a protective sheath.

15. The transducer of any preceding claim further comprising a reference tube containing an optical fibre which does not experience tension when the remainder of the fibres do so.

16. The transducer of claim 15 wherein said reference tube forms at least a part of the core of the strand.

17. The transducer of any of claims 1 to 14 further comprising one or more reference tubes having a helical winding angle which differs from that of the remainder of the tubes.

18. The transducer of any preceding claim wherein the transducer strand comprises a first layer of tubes at a first winding angle on said core, with a further second layer of tubes wound around the first layer at a second winding angle.

19. A load bearing member comprising a number of load bearing strands, and a strain transducer strand, the transducer strand comprising an elongate core, a tube which is helically wound around the core, and an optical fibre housed within the bore of the tube and anchored relative to the bore at at least two points.

20. A method of detecting strain in a load bearing member, the method comprising the steps of:
providing in combination a strain transducer strand comprising an elongate core, a tube which is helically wound around the core, and an optical fibre housed within the bore of the tube and anchored relative to the bore at at least two points; and a load bearing member;
transmitting optical radiation along the optical fibre; and
detecting a change in the character of the optical radiation in the optical fibre resulting from a change in the strain experienced by the optical fibre.

21. The method of claim 20 wherein the change in character of optical radiation is detected by means of stimulated Brillouin scattering.

22. A system for detecting strain in a load bearing member, the system comprising a strain transducer strand comprising an elongate core, a tube which is helically wound around the core, and an optical fibre housed within the bore of the tube and anchored relative to the bore at at least two points; means for generating optical radiation and directing generated optical radiation along said optical fibre; and means for detecting optical radiation transmitted along said fibre.
